(19) United States
(12) Patent Application Publication
(10) Pub. No.: US 2013/0024592 A1
(43) Pub. Date: Jan. 24, 2013

(54) DOCKING STATION FOR COMMUNICATION TERMINAL

(71) Applicant: Dong Jun LEE, Suwon-si (KR)

(72) Inventor: Dong Jun LEE, Suwon-si (KR)

(73) Assignee: SAMSUNG ELECTRONICS CO. LTD., Suwon-si, (KR)

(21) Appl. No.: 13/551,081

(22) Filed: Jul. 17, 2012

(30) Foreign Application Priority Data
Jul. 20, 2011 (KR) 10-2011-0071803
Oct. 24, 2011 (KR) 10-2011-0105822

(51) Int. Cl. G06F 13/00

(52) U.S. Cl. 710/303

(57) ABSTRACT

A docking station for a communication terminal having an antenna for a radio communication is provided. The docking station includes a docking unit, a fastening unit, and a pattern unit. The docking unit is configured to be joined to the communication terminal and to provide an interface with the communication terminal. The fastening unit is coupled with the docking unit, configured to fixedly hold the communication terminal, and electrically coupled to the antenna through an electromagnetic field created in the antenna when the antenna operates. The pattern unit is disposed on the docking unit so as to be extended from the fastening unit, and configured to perform the radio communication together with the antenna by being electrically coupled to the antenna through the fastening unit when the antenna operates.

### PRIORITY

This application claims the benefit under 35 U.S.C. §119(a) of Korean patent applications filed on Jul. 20, 2011 and Oct. 24, 2011 in the Korean Intellectual Property Office and assigned Serial Nos. 10-2011-0071803 and 10-2011-0108522, the entire disclosure of each of which is hereby incorporated by reference.

### BACKGROUND OF THE INVENTION

1. Field of the Invention

The present invention relates in general to a docking station. More particularly, the present invention relates to a docking station designed for a communication terminal.

2. Description of the Related Art

Unlike a desktop computer, a portable communication terminal does not have an interface that can be easily joined to an external device such as a local printer, a backup drive, or a mass storage device. To address this problem, a docking station has been proposed for providing such an additional interface. For example, a docking station joined to the portable communication terminal can output audio signals of the portable communication terminal through a speaker or can display image data of the portable communication terminal through its display module.

However, a portable communication terminal joined to such a docking station may be faced with a problem that communication quality is lowered due radiation performance degradation of an antenna. Therefore, the use of the docking station as an interface may cause a portable communication terminal to have difficulty in performing a seamless radio communication.

### SUMMARY OF THE INVENTION

Aspects of the present invention are to address at least the above-mentioned problems and/or disadvantages and to provide at least the advantages described below. Accordingly, an aspect of the present invention is to improve the communication quality of a communication terminal by preventing the radiation performance of an antenna from being degraded when the communication terminal is joined to a docking station.

Another aspect of the present invention is to allow a docking station to perform an interfacing function for a communication terminal without impeding a seamless radio communication.

In accordance with an aspect of the present invention, a docking station for a communication terminal having an antenna for radio communication is provided. The docking station includes a docking unit for joining to the communication terminal and for providing an interface with the communication terminal, a fastening unit coupled with the docking unit, for fixedly holding the communication terminal to the docking unit, and electrically coupled to the antenna through an electromagnetic field created in the antenna when the antenna operates, and a pattern unit disposed on the docking unit so as to be extended from the fastening unit, for performing radio communication together with the antenna by being electrically coupled to the antenna through the fastening unit when the antenna operates.

In an exemplary implementation, the docking unit may include a display module configured to display image data, a control module disposed on a rear face of the display module and configured to provide the image data to the display module, and an interface connector protruded from the control module and configured to be connected to the communication terminal so as to fix the communication terminal to the display module and so as to receive the image data from the communication terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a communication terminal according to an exemplary embodiment of the present invention.

FIG. 2 is a front perspective view illustrating a docking station according to a first exemplary embodiment of the present invention.

FIG. 3 is a rear perspective view illustrating a docking station according to the first exemplary embodiment of the present invention.

FIG. 4 is a block diagram illustrating a docking unit of a docking station according to the first exemplary embodiment of the present invention.

FIG. 5 is a front perspective view illustrating a docking station according to a second exemplary embodiment of the present invention.

FIG. 6 is a rear perspective view illustrating a docking station according to the second exemplary embodiment of the present invention.

FIG. 7 is a block diagram illustrating a docking unit of a docking station according to the second exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

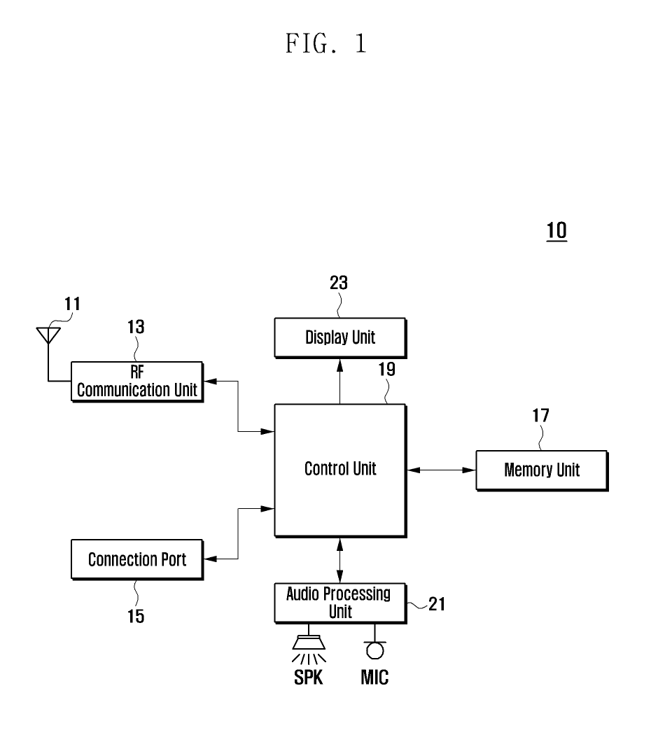

FIG. 1 is a block diagram illustrating a configuration of a communication terminal according to an exemplary embodiment of the present invention.

Referring to FIG. 1, the communication terminal 10 generally includes an antenna 11, a Radio Frequency (RF) communication unit 13, a connection port 15, a memory unit 17, a control unit 19, an audio processing unit 21, and a display unit 23. As an example, the communication terminal 10 may be a mobile phone.

The antenna 11 supports a radio communication function of the communication terminal 10. The antenna 11 operates at a resonant frequency and therefore transmits and receives radio signals while forming an electromagnetic field in its surrounding area. The antenna 11 may be disposed at a specific location of the communication terminal 10. For example, the antenna 11 may be disposed at the lower end of the terminal 10. Alternatively, the antenna 11 may be composed of a main antenna and a sub antenna, which may be separately disposed at different ends of the terminal 10. For example, the main antenna and the sub antenna may be disposed at the lower and upper ends of the terminal 10, respectively.

The RF communication unit 13 performs a radio communication function of the communication terminal 10. The radio communication unit 13 includes an RF transmitter that up-converts the frequency of an outgoing signal and amplifies the signal, an RF receiver that amplifies with low-noise an incoming signal and down-converts the frequency of the signal, and the like. The RF communication unit 13 may further include at least one internal switch that is disposed between the antenna 11 and the control unit 19 and provides a transmission path of radio signals. Namely, the internal switch part may complete a transmission path of radio signals by connecting the antenna 11 and the control unit 19 and may also cut off the transmission path by separating the antenna 11 and the control unit 19. If the antenna 11 is composed of the main antenna and the sub antenna, each internal switch part may be disposed between the main antenna and the control unit 19 and between the sub antenna and the control unit 19. The transmission path of radio signals may be selectively formed between the main antenna and the control unit 19 and/or between the sub antenna and the control unit 19.

The connection port 15 provides a mechanical and an electrical interface between the communication terminal 10 and an external device. The connection port 15 is externally exposed from the communication terminal 10.

The memory unit 17 may be composed of a program memory and a data memory. The program memory stores various programs for controlling the general operation of the communication terminal 10. The data memory stores data that is created during execution of such programs.

The control unit 19 performs one or more functions to control the general operation of the communication terminal 10. The control unit 19 may include a data processing unit that has a transmitter for encoding and modulating outgoing signals and a receiver for demodulating and decoding incoming signals. This data processing unit may be composed of a modulator/demodulator (MODEM) and a Coder/Decoder (CODEC). Here, the CODEC may include a data CODEC for processing data and an audio CODEC for processing audio signals such as voices. The control unit 19 may operate the antenna 11 by supplying power to the antenna 11. Additionally, the control unit 19 may perform a communication with an external device through the connection port 15. Also, the control unit 19 may selectively drive the antenna 11 by controlling the internal switch part in the radio communication unit 13. If the antenna 11 is composed of the main antenna and the sub antenna, the control unit 19 may select one of the main antenna and the sub antenna and control the internal switch part to provide the transmission path of radio signals.

The audio processing unit 21 performs a function to reproduce audio signals outputted from the audio CODEC of the data processing unit through a speaker (SPK) or to send audio signals generated through a microphone (MIC) to the audio CODEC of the data processing unit.

The display unit 23 displays data outputted from the control unit 19. The display unit 23 may employ a Liquid Crystal Display (LCD). In this case, the display unit 23 may have an LCD controller, a memory for storing image data, an LCD panel, and the like. If the LCD is embodied in the form of a touch screen, it may also operate as an input unit. The touch screen creates a touch signal by detecting a touch thereon.

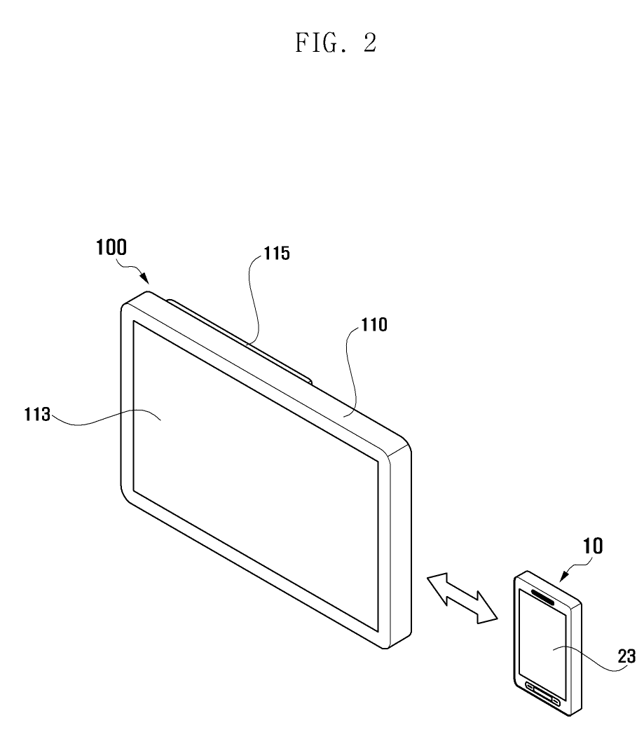

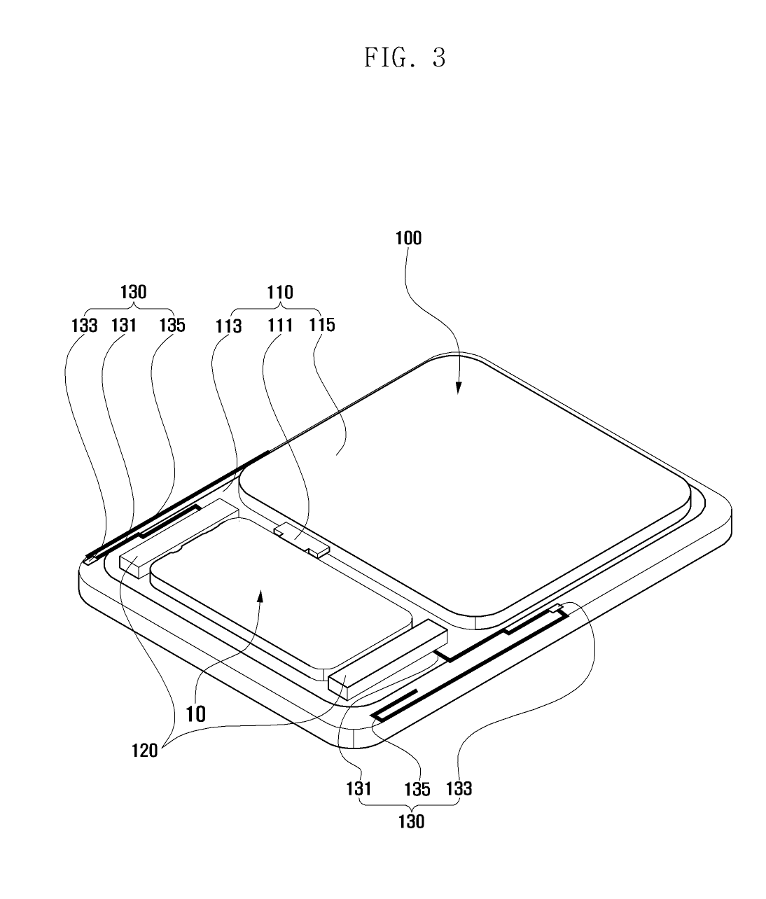

FIG. 2 is a front perspective view illustrating a docking station according to a first exemplary embodiment of the present invention. FIG. 3 is a rear perspective view illustrating a docking station according to the first exemplary embodiment of the present invention.

Referring to FIGS. 2 and 3, the docking station 100 may be joined mechanically and electrically to the communication terminal 10. The docking station 100 includes a docking unit 110, a fastening unit 120, and a pattern unit 130.

The docking unit 110 may provide additive functions to the communication terminal 10. To provide the additive functions, the docking unit 110 may be electrically coupled to the communication terminal 10. Namely, the docking unit 110 has an interface connector 111 that is connectable to the connection port 15 of the communication terminal 10. The interface connector 111 not only provides an electrical interface between the docking station 100 and the communication terminal 10, but also provides a structural connection between the communication terminal 10 and the docking unit 110.

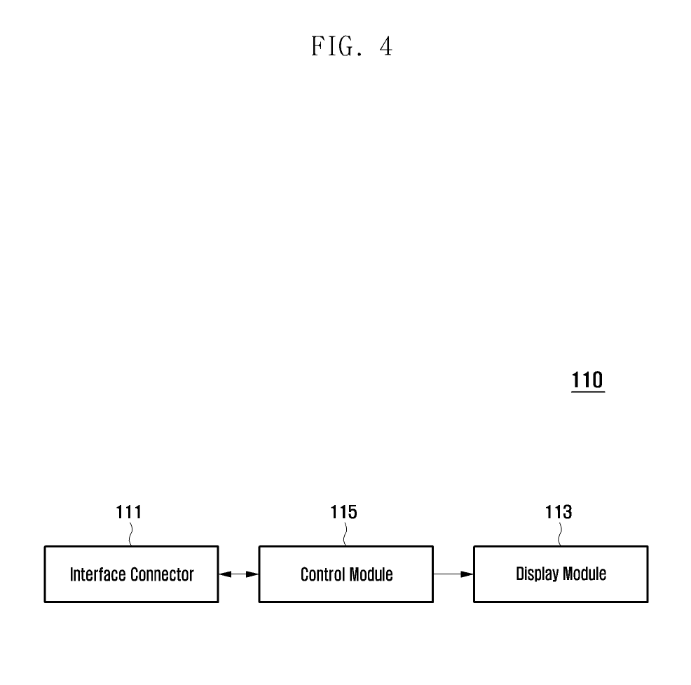

FIG. 4 is a block diagram illustrating a docking unit of a docking station according to the first exemplary embodiment of the present invention.

Referring to FIGS. 2 to 4, the docking unit 110 has the interface connector 111, a display module 113, and a control module 115. That is, the docking unit 110 in this exemplary embodiment is formed as a display device.

The interface connector 111 provides an interface between the docking station 100 and the communication terminal 10. The interface connector 111 has a specific structure adapted to the connection port 15 of the communication terminal 10 and is therefore electrically coupled to the connection port 15 of the communication terminal 10. Also, the interface connector 111 establishes a structural connection with the connection port 15 of the communication terminal 10.

The display module 113 displays data of the communication terminal 10. The display module 113 may employ an LCD. In this case, the display module 113 may have an LCD controller, a memory for storing image data, an LCD panel, and the like. If the LCD is embodied in the form of a touch screen, it may also operate as an input unit. The touch screen creates a touch signal by detecting a touch thereon.

The control module 115 performs a function to control the general operation of the docking station 100. More particularly, the control unit 115 performs a communication with the communication terminal 10 through the interface connector 111. As an example, when connected to the connection port 15 of the communication terminal 10 through the interface connector 111, the control module 115 receives data from the communication terminal 10. The control module 115 processes the received data and may display the data as images through the display module 113. Additionally, the control module 115 may support controlling of the internal switch part in the communication terminal 10. As an example, the control module 115 may send a signal for controlling the internal switch part to the terminal 10.

In the above-discussed docking unit 110, the display module 113 may display images through a front face, and the interface connector 111 and the control module 115 may be disposed on a rear face of the display module 113. More particularly, the control module 115 may be located toward one lateral side of the display module 113 on the rear face of the display module 113 so as to provide a mounting space for the terminal 10 on the rear face of the display module 113. The interface connector 111 allows for an easy connection with the connection port 15 of the communication terminal 10 and may protrude from the control module 115 to the mounting space for the terminal 10. Therefore, when the terminal 10 is placed in the mounting space on the rear face of the display module 113, the interface connector 111 is directly connected to the connection port 15 of the terminal 10 and also forces the terminal 10 to be closely fixed onto the rear face of the display module 113.

The fastening unit 120 is installed on the docking unit 110 and holds the communication terminal 10 to the docking unit 110. The fastening unit 120 may have a structure suitable for providing a fastening path for the communication terminal 10 on the docking unit 110. For example, the fastening unit 120 may be formed of two guide bars, which may be spaced apart from each other at an interval corresponding to the length or width of the communication terminal 10 on the surface of the docking unit 110. As an example, these guide bars may be installed in the mounting space for the terminal 10 on the rear face of the display module 113 so as to be respectively disposed at both ends of the terminal 10. Therefore, the terminal 10 may be guided toward the interface connector 111 from the outside of the docking unit 110 and fixed onto the rear face of the display module 113.

Additionally, the fastening unit 120 may be electrically coupled to the antenna 11 of the communication terminal 10. Therefore, the fastening unit 120 may be formed of electrically conductive metallic material. As an example, when connected to the communication terminal 10, the fastening unit 120 may be electrically coupled to the antenna 11 through the electromagnetic field created in a surrounding area of the antenna 11. In this situation, power from the electromagnetic field is supplied from the antenna 11 of the communication terminal 10 to the fastening unit 120. If the antenna 11 is composed of the main antenna and the sub antenna, one or both of the main antenna and the sub antenna may selectively operate and thereby the power may be supplied to one or both of the guide bars of the fastening unit 120.

The pattern unit 130 is installed on the docking unit 110 and extended from the fastening unit 120. The pattern unit 130 may be disposed on the docking unit 110 through patterning so as to be extended along the surface of the docking unit 110. In an exemplary implementation, the pattern unit 130 may have at least one curved part. More specifically, the pattern unit 130 may be formed having at least one of a meander type, a spiral type, a step type, a loop type, and the like. For example, the pattern unit 130 may have two main pattern parts 131. Each of the main pattern parts 131 may be extended from each guide bar. Namely, the main pattern parts 131 may be respectively disposed at both ends of the communication terminal 10. In an exemplary implementation, the first end of each main pattern part 131 is connected to the guide bar, and the second end is open.

Additionally, the pattern unit 130 may be electrically coupled to the antenna 11 of the communication terminal 10 through the fastening unit 120. Therefore, the pattern unit 130 is formed of electrically conductive material, such as a metal. In an exemplary implementation, the material of the pattern unit 130 may be the same as that of the antenna 11 of the communication terminal 10. When the fastening unit 120 is electrically coupled to the antenna 11 through the electromagnetic field created in a surrounding area of the antenna 11, the electric power is supplied from the fastening unit 120 to the pattern unit 130. If the antenna 11 is composed of the main antenna and the sub antenna, the electric power may be supplied to one of the main pattern parts 131 through one of the guide bars of the fastening unit 120. Therefore, when the antenna 11 operates, the pattern unit 130 operates together with the antenna 11 and supports a radio communication function of the communication terminal 10.

The pattern unit 130 may further have two external switch parts 133 and two sub pattern parts 135. Each external switch part 133 is disposed at the second end of each main pattern part 131, and each sub pattern part 135 is extended from each external switch part 133. The first end of each sub pattern part 135 is connected to the external switch part 133, and the second end is open. Namely, the sub pattern parts 135 are spaced from the main pattern parts 131 by the external switch parts 133. Each external switch part 133 is interposed between the main pattern part 131 and the sub pattern part 135 and provides a connection between the main pattern part 131 and the sub pattern part 135 under the control of the control module 115.

When the main pattern part 131 and the sub pattern part 135 are connected through the external switch part 133, electric power is supplied from the main pattern part 131 to the sub pattern part 135 through the external switch part 133. Therefore, when the antenna 11 operates, both the main pattern part 131 and the sub pattern part 135 operate together with the antenna 11 and perform a radio communication. Meanwhile, when the main pattern part 131 and the sub pattern part 135 are disconnected through the external switch part 133, electric power is not supplied from the main pattern part 131 to the sub pattern part 135 through the external switch part 133. Therefore, the main pattern part 131 operates together with the antenna 11 and performs a radio communication when the antenna 11 operates, but the sub pattern part 135 does not operate.

In the docking station 100 of this exemplary embodiment, the fastening unit 120 and the pattern unit 130 are disposed on the rear face of the display module 113. Therefore, when the communication terminal 10 is fastened to the fastening unit 120, the fastening unit 120 as well as the interface connector 111 can closely fix the communication terminal 10 onto the rear face of the display module 113. In the end, the docking station 100 and the communication terminal 10 are mechanically connected to each other. Also, when the interface connector 111 is connected to the connection port 15 of the communication terminal 10, the docking station 100 and the communication terminal 10 are electrically coupled to each other. By performing an interface with the communication terminal 10, the docking station 100 can display data of the communication terminal 10. Additionally, the fastening unit 120 and the pattern unit 130 are electrically coupled to the antenna 11 of the communication terminal 10 through the electromagnetic field of the antenna 11. At this time, as the pattern unit 130 operates together with the antenna 11, the docking station 100 can enhance the radio communication performance of the communication terminal 10.

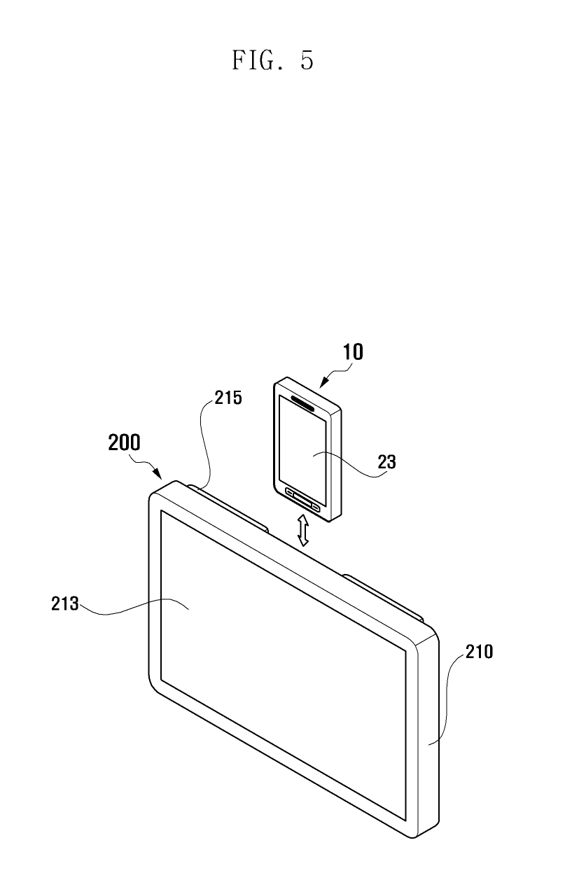

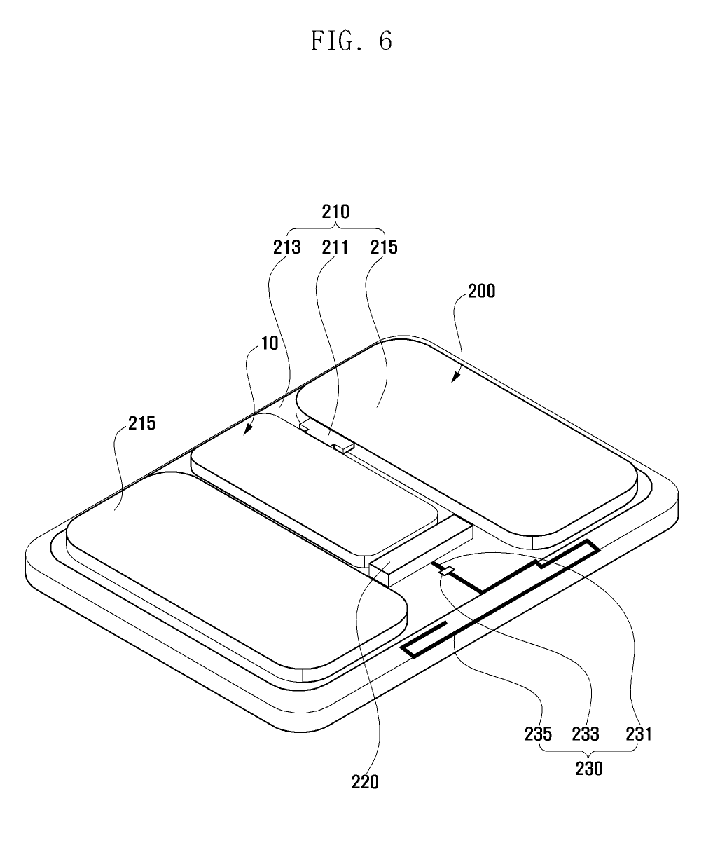

FIG. 5 is a front perspective view illustrating a docking station according to a second exemplary embodiment of the present invention. FIG. 6 is a rear perspective view illustrating a docking station according to the second exemplary embodiment of the present invention.

Referring to FIGS. 5 and 6, the docking station 200 can be joined mechanically and electrically to the communication terminal 10. The docking station 200 includes a docking unit 210, a fastening unit 220, and a pattern unit 230.

The docking unit 210 may provide additive functions to the communication terminal 10. To provide the additive functions, the docking unit 210 may be electrically coupled to the communication terminal 10. Namely, the docking unit 210 has an interface connector 211 that is connected to the connection port 15 of the communication terminal 10. The interface connector 211 not only provides an interface between the docking station 200 and the communication terminal 10, but also provides a structural connection between the communication terminal 10 and the docking unit 210.

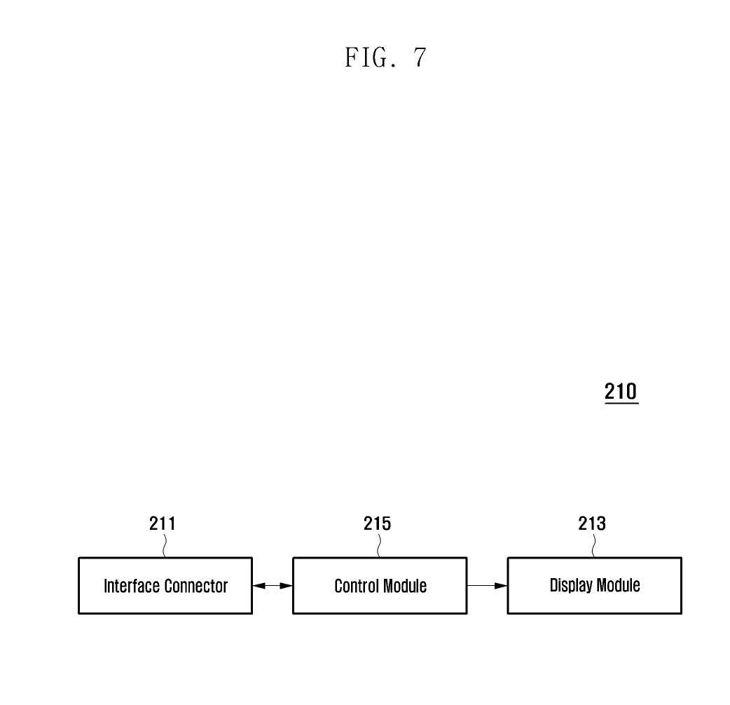

FIG. 7 is a block diagram illustrating a docking unit of a docking station according to the second exemplary embodiment of the present invention.

Referring to FIGS. 5 to 7, the docking unit 210 has the interface connector 211, a display module 213, and a control module 215. In an exemplary implementation, the display module 213 displays images through a front face, and the interface connector 211 and the control module 215 are disposed on a rear face of the display module 213. The interface connector 211, the display module 213, and the control module 215 used in the second exemplary embodiment are similar to those used in the first exemplary embodiment, so repeated descriptions will be avoided hereinafter.

The control module 215 is composed of two control parts. These control parts are separately disposed on the rear face of the display module 213 not only to provide a mounting space for the terminal 10, but also to guide a mounting direction of the terminal 10. As an example, the control parts may be spaced apart from each other at an interval corresponding to the length or width of the communication terminal 10 on the surface of the docking unit 210. Therefore, the terminal 10 may be guided to the mounting space from the outside of the docking unit 210 and fixed onto the rear face of the display module 213.

The interface connector 211 is configured to provide a structural connection with the connection port 15 of the communication terminal 10 and may protrude from one of the control parts of the control module 215 to the mounting space for the terminal 10. Therefore, when the terminal 10 is placed in the mounting space on the rear face of the display module 213, the interface connector 211 is directly connected to the connection port 15 of the terminal 10 and also forces the terminal 10 to be closely fixed onto the rear face of the display module 213.

The fastening unit 220 is installed on the docking unit 210 and holds the communication terminal 10 to fix it to the docking unit 210. The fastening unit 220 may have a bar shape. Additionally, the fastening unit 220 is disposed in the mounting space for the terminal 10 on the rear face of the display module 213. Namely, the fastening unit 220 is disposed between two control parts of the control module 215. Also, the fastening unit 220 supports the communication terminal 10 on the rear face of the display module 213. Namely, when the terminal 10 is guided between the control parts, the fastening unit 220 is located at the lower end of the terminal 10. Therefore, the terminal 10 may be fixed onto the rear face of the display module 213 by the fastening unit 220 together with two control parts.

Additionally, the fastening unit 220 may be electrically coupled to the antenna 11 of the communication terminal 10. Therefore, the fastening unit 220 may be formed of an electrically conductive material, such as a metal. As an example, when connected to the communication terminal 10, the fastening unit 220 may be electrically coupled to the antenna 11 through an electromagnetic field created in a surrounding area of the antenna 11. In this situation, power from the electromagnetic field is supplied from the antenna 11 of the communication terminal 10 to the fastening unit 220. If the antenna 11 is composed of the main antenna and the sub antenna, the main antenna and the sub antenna may selectively operate and thereby the electric power may be supplied to the fastening unit 220.

The pattern unit 230 is installed on the docking unit 210 and extended from the fastening unit 220. The pattern unit 230 may be disposed on the docking unit 210 through patterning so as to be extended along the surface of the docking unit 210. In an exemplary implementation, the pattern unit 230 may have at least one curved part. More specifically, the pattern unit 230 may be formed having at least one of a meander type, a spiral type, a step type, a loop type, and the like. For example, the pattern unit 230 may have a main pattern part 231. The main pattern part 231 may be extended from the fastening unit 220. Namely, the main pattern part 231 may be disposed at the lower end of the communication terminal 10. The first end of the main pattern part 231 is connected to the fastening unit 220, and the second end is open.

Additionally, the pattern unit 230 may be electrically coupled to the antenna 11 of the communication terminal 10 through the fastening unit 220. Therefore, the pattern unit 230 is formed of electrically conductive material, such as a metal. In an exemplary implementation, the material of the pattern unit 230 may be the same as that of the antenna 11 of the communication terminal 10. When the fastening unit 220 is electrically coupled to the antenna 11 through the electromagnetic field created in a surrounding area of the antenna 11, electric power is supplied from the fastening unit 220 to the pattern unit 230. If the antenna 11 is composed of the main antenna and the sub antenna, the electric power may be supplied to the main pattern part 231 through the fastening unit 220. Therefore, when the antenna 11 operates, the pattern unit 230 also operates together with the antenna 11 and supports a radio communication function of the communication terminal 10.

The pattern unit 230 may further have an external switch part 233 and a sub pattern part 235. The external switch part 233 is disposed at the second end of the main pattern part 231, and the sub pattern part 235 is extended from the external switch part 233. The first end of the sub pattern part 235 is connected to the external switch part 233, and the second end is open. Namely, the sub pattern part 235 is spaced from the main pattern part 231 by the external switch part 233. The external switch part 233 is interposed between the main pattern part 231 and the sub pattern part 235 and provides a connection between the main pattern part 231 and the sub pattern part 235 under the control of the control module 215.

When the main pattern part 231 and the sub pattern part 235 are connected through the external switch part 233, electric power is supplied from the main pattern part 231 to the sub pattern part 235 through the external switch part 233. Therefore, when the antenna 11 operates, both the main pattern part 231 and the sub pattern part 235 operate together with the antenna 11 and perform a radio communication. Meanwhile, when the main pattern part 231 and the sub pattern part 235 are disconnected through the external switch part 233, electric power is not supplied from the main pattern part 231 to the sub pattern part 235 through the external switch part 233. Therefore, the main pattern part 231 operates together with the antenna 11 and performs a radio communication when the antenna 11 operates, but the sub pattern part 235 does not operate.

In the docking station 200 of this exemplary embodiment, the fastening unit 220 and the pattern unit 230 are disposed on the rear face of the display module 213. Therefore, when the communication terminal 10 is fastened to the fastening unit 220, the fastening unit 220 as well as the interface connector 211 can closely fix the communication terminal 10 onto the rear face of the display module 213. In the end, the docking station 200 and the communication terminal 10 are mechanically connected to each other. Also, when the interface connector 211 is connected to the connection port 15 of the communication terminal 10, the docking station 200 and the communication terminal 10 are electrically coupled to each other. By performing an interface with the communication terminal 10, the docking station 200 can display data of the communication terminal 10. Additionally, the fastening unit 220 and the pattern unit 230 are electrically coupled to the antenna 11 of the communication terminal 10 through the electromagnetic field of the antenna 11. At this time, as the pattern unit 230 operates together with the antenna 11, the docking station 200 can enhance the radio communication performance of the communication terminal 10.

Although in the above exemplary embodiments the docking units 110 and 210 of the docking stations 100 and 200 are formed as a display device, this is not to be considered as a limitation of the present invention. Alternatively, the docking units 110 and 210 may be embodied as a supporting device, a recharging device, or an audio output device for the communication terminal 10.

As discussed above, when the communication terminal 10 is connected to the docking station 100 or 200, the docking station 100 or 200 supports a radio communication function of the communication terminal 10. That is, even though the communication terminal 10 is joined to the docking station 100 or 200, the radiation performance of the antenna 11 is not degraded. Therefore, the docking station 100 or 200 not only can perform an interfacing function for the communication terminal 10, but also can perform a seamless radio communication.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A docking station for a communication terminal having an antenna, the docking station comprising:
a docking unit for joining to the communication terminal and for providing an interface with the communication terminal;
a fastening unit, coupled with the docking unit, for fixedly holding the communication terminal to the docking unit, and electrically coupled to the antenna through an electromagnetic field created in the antenna when the antenna operates; and
a pattern unit, disposed on the docking unit so as to be extended from the fastening unit, for performing radio communication together with the antenna by being electrically coupled to the antenna through the fastening unit when the antenna operates.

2. The docking station of claim 1, wherein the docking unit comprises:
a control module disposed on a rear face of the docking unit; and
an interface connector, protruding from the control module, for connection to the communication terminal so as to fix the communication terminal to the docking unit.

3. The docking station of claim 2, wherein the docking unit further comprises a display module for displaying image data and the control module is disposed on a rear face of the display unit and the interface, and wherein the control module controls to provide image data from the communication terminal to the display module, and the interface connector receives the image data from the communication terminal.

4. The docking station of claim 3, wherein the fastening unit and the pattern unit are disposed near one end of the control module on the rear face of the display module and are both disposed at both ends of the communication terminal.

5. The docking station of claim 3, wherein the fastening unit and the pattern unit are disposed in a space between separately spaced control parts of the control module on the rear face of the display module and disposed at one end of the communication terminal.

6. The docking station of claim 2, further comprising a speaker, wherein the control module controls to provide audio data from the communication terminal to the speaker, and the interface connector receives the audio data from the communication terminal.

7. The docking station of claim 1, wherein the pattern unit comprises:
a main pattern part extended from the fastening unit;
a sub pattern part spaced apart from the main pattern part; and
a switch part interposed between the main pattern part and the sub pattern part for controlling a connection between the main pattern part and the sub pattern part.

8. The docking station of claim 7, wherein the main pattern part is configured to perform radio communication together with both the antenna and the sub pattern part when connected to the sub pattern part through the switch part, and to perform radio communication together with the antenna when disconnected from the sub pattern part through the switch part.

9. The docking station of claim 2, wherein the communication terminal includes:
at least two antennas; and
a switch part configured to connect one of the antennas to the interface connector when the communication terminal is coupled to the interface connector.

10. The docking station of claim 9, wherein the switch part operates under the control of the control module.

11. The docking station of claim 1, wherein the pattern unit comprises a metal.

12. The docking station of claim 1, wherein the fastening unit comprises a metal.
